(19) United States
(12) Patent Application Publication
(10) Pub. No.: US 2026/0261383 A1
(43) Pub. Date: Sep. 3, 2026

(54) METHODS AND APPARATUSES FOR RECONFIGURABLE INTELLIGENT SURFACE ASSISTED POSITIONING

(71) Applicant: LENOVO (BEIJING) LIMITED, Beijing (CN)

(72) Inventors: Lihua Yang, Beijing (CN); Tingnan Bao, Beijing (CN); Haiming Wang, Beijing (CN); Jianfeng Wang, Beijing (CN)

(21) Appl. No.: 19/163,817

(22) PCT Filed: Mar. 10, 2023
(86) PCT No.: PCT/CN2023/080737

§ 371 Date: Sep. 9, 2025

(51) Int. Cl. H04L 5/00; H04B 7/04; H04W 64/00

(52) U.S. Cl. CPC H04L 5/0051; H04B 7/04013; H04W 64/00

(57) ABSTRACT

Embodiments of the present disclosure relate to methods and apparatuses for reconfigurable intelligent surface (RIS) assisted positioning. According to an embodiment of the present disclosure, a location management function can include: a transceiver; and a processor coupled to the transceiver and configured to: transmit, via the transceiver and to a base station (BS), a request message requesting positioning reference signal (PRS) configuration(s) for a RIS-assisted downlink positioning or sounding reference signal (SRS) configuration(s) for a RIS-assisted uplink positioning; and receive, via the transceiver, the PRS configuration(s) or the SRS configuration(s) from the BS.

### TECHNICAL FIELD

Embodiments of the present application generally relate to wireless communication technologies, and especially to methods and apparatuses for reconfigurable intelligent surface (RIS) assisted positioning.

### BACKGROUND

RIS is a promising technology to improve the positioning accuracy for wireless networks. Specifically, a RIS may be a planar surface including many reflecting elements, and can be deployed on the surfaces of various objects such as walls. The reflection coefficient of the RIS may be adjusted by changing the states of the elements of the RIS. Compared with deploying base stations (BSs), deploying RISs is more flexible, and the cost is lower. With the assistance of RISs, the wireless networks can obtain a higher spatial resolution and positioning accuracy. Currently, details regarding RIS-assisted positioning have not been studied yet.

### SUMMARY OF THE APPLICATION

Embodiments of the present application at least provide technical solutions for RIS-assisted positioning.

According to some embodiments of the present application, a location management function (LMF) may include: a transceiver; and a processor coupled to the transceiver and configured to: transmit, via the transceiver and to a BS, a request message requesting positioning reference signal (PRS) configuration(s) for a RIS-assisted downlink (DL) positioning or sounding reference signal (SRS) configuration(s) for a RIS-assisted uplink (UL) positioning; and receive, via the transceiver, the PRS configuration(s) or the SRS configuration(s) from the BS.

In some embodiments of the present application, the processor is further configured to: determine to initiate the RIS-assisted DL positioning or the RIS-assisted UL positioning; in response to determining to initiate the RIS-assisted DL positioning or the RIS-assisted UL positioning, transmit, via the transceiver, a request message for requesting available RIS(s); and receive, via the transceiver, information of the available RIS(s), wherein the information of the available RIS(s) includes at least one of: location(s) of the available RIS(s) or a number of elements of each available RIS.

In some embodiments of the present application, the processor is further configured to: transmit, via the transceiver, a transmit-receive point (TRP) information request message to the BS; receive, via the transceiver, an indication indicating to initiate the RIS-assisted DL positioning or the RIS-assisted UL positioning from the BS, wherein the indication is a RIS-assisted positioning request message or received in a TRP information response message from the BS; and determine to initiate the RIS-assisted DL positioning or the RIS-assisted UL positioning in response to receiving the indication.

In some embodiments of the present application, the processor is further configured to: receive, via the transceiver and from the BS, a TRP information response message indicating a minimum number of TRPs and a number of candidate TRPs; compare the number of candidate TRPs with the minimum number of TRPs; and determine to initiate the RIS-assisted DL positioning or the RIS-assisted UL positioning in response to that the number of candidate TRPs is less than the minimum number of TRPs.

In some embodiments of the present application, the processor is further configured to: determine to initiate the RIS-assisted DL positioning in response to receiving, via the transceiver, an indication indicating to initiate the RIS-assisted DL positioning from a user equipment (UE), wherein the indication is a RIS-assisted positioning request message or received in a provide location information message from the UE.

In some embodiments of the present application, the processor is further configured to: transmit, via the transceiver and to the UE, a provide assistance data message indicating a minimum number of TRPs configured by a BS and a number of candidate TRPs.

In some embodiments of the present application, the processor is further configured to: determine to initiate the RIS-assisted UL positioning in response to receiving, via the transceiver, an indication indicating to initiate the RIS-assisted UL positioning from the BS, wherein the indication is a RIS-assisted positioning request message or received in a measurement response message from the BS.

In some embodiments of the present application, the processor is further configured to: transmit, via transceiver and to the BS, a RIS capability request message requesting capability information of the available RIS(s); and receive, via the transceiver, the capability information of the available RIS(s) from the BS, wherein the capability information includes capability of tuning coefficients and properties of RIS element(s) included in each of the available RIS(s) according to control information from the BS.

In some embodiments of the present application, the processor is configured to: transmit, via the transceiver and to the BS, the request message requesting the PRS configuration(s) after receiving the capability information of the available RIS(s), wherein the PRS configuration(s) includes a PRS configuration for a direct link from the BS to a UE and a PRS configuration for a cascade link including a link from the BS to a RIS and a link from the RIS to the UE; and receive, via the transceiver, the PRS configuration for the direct link and the PRS configuration for the cascade link from the BS.

In some embodiments of the present application, the processor is configured to: transmit, via the transceiver, the capability information of the available RIS(s) to a UE; receive, via the transceiver, an on-demand PRS request message for the RIS-assisted DL positioning from the UE; transmit, via the transceiver, the request message requesting the PRS configuration(s) based on the on-demand PRS request message, wherein the PRS configuration(s) includes a PRS configuration for a direct link from the BS to the UE and a PRS configuration for a cascade link including a link from the BS to a RIS and a link from the RIS to the UE; and receive, via the transceiver, the PRS configuration for the direct link and the PRS configuration for the cascade link.

In some embodiments of the present application, the processor is further configured to transmit, via the transceiver, the PRS configuration for the direct link and the PRS configuration for the cascade link to the UE.

In some embodiments of the present application, the PRS configuration for the cascade link indicates a first list of DL PRS resource sets per TRP in each frequency layer, and wherein DL PRS resource set(s) included in the first list is different from DL PRS resource set(s) included in a second list of DL PRS resource sets which is configured per TRP in each frequency layer and included in the PRS configuration for the direct link from the BS to the UE.

In some embodiments of the present application, each DL PRS resource set included in the first list is defined by a set of parameters including at least one of: a first parameter indicating an identity (ID) of the DL PRS resource set; a second parameter indicating a periodicity and an offset for the DL PRS resource set; a third parameter indicating how many times each DL PRS resource is repeated for a single instance of the DL PRS resource set; a fourth parameter indicating an offset between two repeated instances of a DL PRS resource; a fifth parameter indicating a number of symbols of a DL PRS resource within a slot; a sixth parameter indicating an average energy per resource element of the resources elements that carry PRS; or a seventh parameter indicating a set of DL PRS resources.

In some embodiments of the present application, the processor is further configured to: transmit, via the transceiver, a request location information message to the UE; receive, via the transceiver and from the UE, PRS measurement results of the direct link and the cascade link in a provide location information message; and calculate a positioning result of the UE based at least in part on the PRS measurement results.

In some embodiments of the present application, the request message requesting the SRS configuration(s) is a positioning information request message, and the processor is configured to: transmit, via the transceiver and to the BS, the positioning information request message after receiving the capability information of the available RIS(s), wherein the SRS configuration(s) includes an SRS configuration for a direct link from a UE to the BS and an SRS configuration for a cascade link including a link from the UE to a RIS and a link from the RIS to the BS; and receive, via the transceiver and from the BS, the SRS configuration for the direct link and the SRS configuration for the cascade link in a positioning information response message.

In some embodiments of the present application, the request message requesting the SRS configuration(s) is a positioning activation request message, and the processor is configured to: transmit, via the transceiver and to the BS, the positioning activation request message after receiving the capability information of the available RIS(s), wherein the positioning activation request message actives an SRS transmission for a direct link from a UE to the BS and an SRS transmission for a cascade link including a link from the UE to a RIS and a link from the RIS to the BS and requests an SRS configuration for the direct link and an SRS configuration for the cascade link; and receive, via the transceiver, the SRS configuration for the direct link and the SRS configuration for the cascade link in a positioning activation response message from the BS.

In some embodiments of the present application, the SRS configuration for the cascade link indicates at least one of a first list of SRS positioning resource sets to be released or a second list of SRS positioning resource sets to be added or modified; and SRS positioning resource set(s) included in the first list is different from SRS positioning resource set(s) included in a third list of SRS positioning resource sets to be released which is configured for the direct link from the UE to the BS, or SRS positioning resource set(s) included in the second list is different from SRS positioning resource set(s) included in a fourth list of SRS positioning resource sets to be added or modified which is configured for the direct link.

In some embodiments of the present application, each SRS positioning resource set included in the first list or the second list is defined by a set of parameters including at least one of: a first parameter indicating an ID of the SRS positioning resource set; a second parameter indicating IDs of SRS positioning resources in the SRS positioning resource set; or a third parameter indicating that the SRS positioning resources in the SRS positioning resource set are periodic, semi-persistent, or aperiodic.

In some embodiments of the present application, the processor is further configured to: transmit, via the transceiver, a measurement request message to the BS; receive, via the transceiver and from the BS, SRS measurement results of the direct link and the cascade link in a measurement response message; and calculate a positioning result of the UE based at least in part on the SRS measurement results.

According to some embodiments of the present application, a BS may include: a transceiver; and a processor coupled to the transceiver and configured to: receive, via the transceiver and from an LMF, a request message requesting PRS configuration(s) for a RIS-assisted DL positioning or SRS configuration(s) for a RIS-assisted UL positioning; and transmit, via the transceiver, the PRS configuration(s) or the SRS configuration(s) to the LMF.

In some embodiments of the present application, the processor is further configured to: receive, via the transceiver, a TRP information request message from the LMF; and compare a number of candidate TRPs with a minimum number of TRPs configured by the BS; and transmit, via the transceiver and to the LMF, an indication indicating to initiate the RIS-assisted DL positioning or the RIS-assisted UL positioning in response to that the number of candidate TRPs is less than the minimum number of TRPs; wherein the indication is a RIS-assisted positioning request message or transmitted in a TRP information response message.

In some embodiments of the present application, the processor is further configured to transmit, via the transceiver and to the LMF, a TRP information response message indicating a minimum number of TRPs and a number of candidate TRPs.

In some embodiments of the present application, the processor is further configured to: compare a measured reference signal receiving power (RSRP) value with an RSRP threshold configured by the BS; and transmit, via the transceiver and to the LMF, an indication indicating to initiate the RIS-assisted UL positioning in response to that the measured RSRP value is less than the RSRP threshold; wherein the indication is a RIS-assisted positioning request message or transmitted in a measurement response message.

In some embodiments of the present application, the processor is further configured to receive, via the transceiver, information of available RIS(s) for the RIS-assisted DL positioning or the RIS-assisted UL positioning, wherein the information of the available RIS(s) includes at least one of: location(s) of the available RIS(s) or a number of elements of each available RIS.

In some embodiments of the present application, the processor is further configured to: receive, via the transceiver and from the LMF, a RIS capability request message requesting capability information of the available RIS(s); and transmit, via the transceiver, the capability information of the available RIS(s) in response to receiving the RIS capability request message from the LMF, wherein the capability information includes capability of tuning coefficients and properties of RIS element(s) included in each of the available RIS(s) according to control information from the BS.

In some embodiments of the present application, the processor is configured to: receive, via the transceiver and from the LMF, the request message requesting the PRS configuration(s) after transmitting the capability information of the available RIS(s), wherein the PRS configuration(s) includes a PRS configuration for a direct link from the BS to a UE and a PRS configuration for a cascade link including a link from the BS to a RIS and a link from the RIS to the UE; configure the PRS configuration for the direct link and the PRS configuration for the cascade link; and transmit, via the transceiver, the PRS configurations for the direct link and the PRS configuration for the cascade link to the LMF.

In some embodiments of the present application, the PRS configuration for the cascade link indicates a first list of DL PRS resource sets per TRP in each frequency layer, and wherein DL PRS resource set(s) included in the first list is different from DL PRS resource set(s) included in a second list of DL PRS resource sets which is configured per TRP in each frequency layer and included in the PRS configuration for the direct link from the BS to the UE.

In some embodiments of the present application, each DL PRS resource set included in the first list is defined by a set of parameters including at least one of: a first parameter indicating an ID of the DL PRS resource set; a second parameter indicating a periodicity and an offset for the DL PRS resource set; a third parameter indicating how many times each DL PRS resource is repeated for a single instance of the DL PRS resource set; a fourth parameter indicating an offset between two repeated instances of a DL PRS resource; a fifth parameter indicating a number of symbols of a DL PRS resource within a slot; a sixth parameter indicating an average energy per resource element of the resources elements that carry PRS; or a seventh parameter indicating a set of DL PRS resources.

In some embodiments of the present application, the request message requesting the SRS configuration(s) is a positioning information request message, and the processor is configured to: receive, via the transceiver and from the LMF, the positioning information request message after transmitting the capability information of the available RIS(s), wherein the SRS configuration(s) includes an SRS configuration for a direct link from a UE to the BS and an SRS configuration for a cascade link including a link from the UE to a RIS and a link from the RIS to the BS; configure the SRS configuration for the direct link and the SRS configuration for the cascade link; transmit, via the transceiver and to the LMF, the SRS configuration for the direct link and the SRS configuration for the cascade link in a positioning information response message; and transmit, via the transceiver, the SRS configuration for the direct link and the SRS configuration for the cascade link to the UE.

In some embodiments of the present application, the request message requesting the SRS configuration(s) is a positioning activation request message, and the processor is configured to: receive, via the transceiver and from the LMF, the positioning activation request message after transmitting the capability information of the available RIS(s), wherein the positioning activation request message actives an SRS transmission for a direct link from a UE to the BS and an SRS transmission for a cascade link including a link from the UE to a RIS and a link from the RIS to the BS and requests an SRS configuration for the direct link and an SRS configuration for the cascade link; configure the SRS configuration for the direct link and the SRS configuration for the cascade link; transmit, via the transceiver, the SRS configuration for the direct link and the SRS configuration for the cascade link in a positioning activation response message to the LMF; transmit, via the transceiver, the SRS configuration for the direct link and the SRS configuration for the cascade link to the UE; and activate the SRS transmission for the direct link and the SRS transmission for the cascade link.

In some embodiments of the present application, the SRS configuration for the cascade link indicates at least one of a first list of SRS positioning resource sets to be released or a second list of SRS positioning resource sets to be added or modified; and SRS positioning resource set(s) included in the first list is different from SRS positioning resource set(s) included in a third list of SRS positioning resource sets to be released which is configured for the direct link from the UE to the BS, or SRS positioning resource set(s) included in the second list is different from SRS positioning resource set(s) included in a fourth list of SRS positioning resource sets to be added or modified which is configured for the direct link.

In some embodiments of the present application, each SRS positioning resource set included in the first list or the second list is defined by a set of parameters including at least one of: a first parameter indicating an ID of the SRS positioning resource set; a second parameter indicating IDs of SRS positioning resources in the SRS positioning resource set; or a third parameter indicating that the SRS positioning resources in the SRS positioning resource set are periodic, semi-persistent, or aperiodic.

In some embodiments of the present application, the processor is further configured to: receive, via the transceiver, a measurement request message from the LMF; in response to receiving the measurement request message, measure SRS(s) on the direct link and SRS(s) on the cascade link; and transmit, via the transceiver, SRS measurement results of the direct link and the cascade link to the LMF in a measurement response message.

In some embodiments of the present application, the processor is further configured to: randomly select coefficients for elements in an available RIS; transmit, via the transceiver and to a UE, reference signals via a cascade link including a link from the BS to the available RIS and a link from the available RIS to the UE; receive, via the transceiver, a channel state information (CSI) report of the cascade link from the UE; and tune the coefficients for elements in the available RIS based on the CSI report.

According to some embodiments of the present application, a UE may include: a transceiver; and a processor coupled to the transceiver and configured to: receive, via the transceiver, PRS configuration(s) for a RIS-assisted DL positioning or SRS configuration(s) for a RIS-assisted UL positioning; and receive, via the transceiver, PRS(s) based on the PRS configuration(s) or transmit, via the transceiver, SRS(s) based on the SRS configuration(s).

In some embodiments of the present application, the processor is configured to: receive, via the transceiver and from an LMF, a provide assistance data message indicating a minimum number of TRPs configured by a BS and a number of candidate TRPs; compare the number of candidate TRPs with the minimum number of TRPs; and in response to that the number of candidate TRPs is less than the minimum number of TRPs, transmit, via the transceiver, a RIS-assisted positioning request message to the LMF to initiate the RIS-assisted DL positioning.

In some embodiments of the present application, the processor is configured to: in response to that a measured reference signal receiving power (RSRP) value is less than an RSRP threshold configured by the UE or a calculated positioning result is not satisfied with quality of service (QoS) requirements, transmit, via the transceiver, an indication indicating to initiate the RIS-assisted DL positioning to an LMF, wherein the indication is a RIS-assisted positioning request message or transmitted in a provide location information message.

In some embodiments of the present application, the processor is further configured to: receive, via the transceiver, capability information of available RIS(s) for RIS-assisted DL positioning from an LMF; and transmit, via the transceiver, an on-demand PRS request message for the RIS-assisted DL positioning to the LMF.

In some embodiments of the present application, the PRS configuration(s) includes a PRS configuration for a direct link from a BS to the UE and a PRS configuration for a cascade link including a link from the BS to a RIS and a link from the RIS to the UE, wherein the PRS configuration for the cascade link indicates a first list of DL PRS resource sets per TRP in each frequency layer, and wherein DL PRS resource set(s) included in the first list is different from DL PRS resource set(s) included in a second list of DL PRS resource sets which is configured per TRP in each frequency layer and included in the PRS configuration for the direct link.

In some embodiments of the present application, each DL PRS resource set included in the first list is defined by a set of parameters including at least one of: a first parameter indicating an ID of the DL PRS resource set; a second parameter indicating a periodicity and an offset for the DL PRS resource set; a third parameter indicating how many times each DL PRS resource is repeated for a single instance of the DL PRS resource set; a fourth parameter indicating an offset between two repeated instances of a DL PRS resource; a fifth parameter indicating a number of symbols of a DL PRS resource within a slot; a sixth parameter indicating an average energy per resource element of the resources elements that carry PRS; or a seventh parameter indicating a set of DL PRS resources.

In some embodiments of the present application, the processor is further configured to: receive, via the transceiver, a request location information message from an LMF; in response to receiving the request location information message, measure PRS(s) on a direct link from a BS to the UE and PRS(s) on a cascade link including a link from the BS to a RIS and a link from the RIS to the UE; and calculate a positioning result of the UE based on PRS measurement results of the direct link and the cascade link or transmit, via the transceiver, PRS measurement results of the direct link and the cascade link to the LMF in a provide location information message.

In some embodiments of the present application, the SRS configuration includes an SRS configuration for a direct link from the UE to a BS and an SRS configuration for a cascade link including a link from the UE to a RIS and a link from the RIS to the BS; the SRS configuration for the cascade link indicates at least one of a first list of SRS positioning resource sets to be released or a second list of SRS positioning resource sets to be added or modified; and SRS positioning resource set(s) included in the first list is different from SRS positioning resource set(s) included in a third list of SRS positioning resource sets to be released which is configured for the direct link from the UE to the BS, or SRS positioning resource set(s) included in the second list is different from SRS positioning resource set(s) included in a fourth list of SRS positioning resource sets to be added or modified which is configured for the direct link.

In some embodiments of the present application, each SRS positioning resource set included in the first list or the second list is defined by a set of parameters including at least one of: a first parameter indicating an ID of the SRS positioning resource set; a second parameter indicating IDs of SRS positioning resources in the SRS positioning resource set; or a third parameter indicating that the SRS positioning resources in the SRS positioning resource set are periodic, semi-persistent, or aperiodic.

In some embodiments of the present application, the processor is further configured to: receive, via the transceiver and from a BS, reference signals via a cascade link including a link from the BS to an available RIS and a link from the available RIS to the UE; and transmit, via the transceiver, a CSI report of the cascade link to the BS.

According to some embodiments of the present application, a method performed by an LMF may include: transmitting, to a BS, a request message requesting PRS configuration(s) for a RIS-assisted DL positioning or SRS configuration(s) for a RIS-assisted UL positioning; and receiving the PRS configuration(s) or the SRS configuration(s) from the BS.

According to some embodiments of the present application, a method performed by a BS may include: receiving, from an LMF, a request message requesting PRS configuration(s) for a RIS-assisted DL positioning or SRS configuration(s) for a RIS-assisted UL positioning; and transmitting the PRS configuration(s) or the SRS configuration(s) to the LMF.

According to some embodiments of the present application, a method performed by a UE may include: receiving PRS configuration(s) for a RIS-assisted DL positioning or SRS configuration(s) for a RIS-assisted UL positioning; and receiving PRS(s) based on the PRS configuration(s) or transmitting SRS(s) based on the SRS configuration(s).

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present application;

FIGS. 2A-2D illustrate exemplary methods for initiating a RIS-assisted DL positioning according to some embodiments of the present application;

FIG. 3 illustrates an exemplary procedure for determining available RIS(s) according to some embodiments of the present application;

FIG. 4 illustrates an exemplary procedure for obtaining capability information of available RIS(s) according to some embodiments of the present application;

FIGS. 5A and 5B illustrate exemplary procedures for transferring PRS configurations according to some embodiments of the present application;

FIG. 6 illustrates an exemplary procedure for calculating a positioning result of a UE based on a RIS-assisted DL positioning according to some embodiments of the present application;

FIG. 7 illustrates an exemplary method for initiating a RIS-assisted UL positioning according to some embodiments of the present application;

FIG. 8 illustrates an exemplary procedure for transferring SRS configurations according to some embodiments of the present application;

FIG. 9 illustrates an exemplary procedure for calculating a positioning result of a UE based on a RIS-assisted UL positioning according to some embodiments of the present application; and

FIG. 10 illustrates a simplified block diagram of an exemplary apparatus for RIS-assisted positioning according to some embodiments of the present application.

### DETAILED DESCRIPTION

The detailed description of the appended drawings is intended as a description of the currently preferred embodiments of the present application and is not intended to represent the only form in which the present application may be practiced. It is to be understood that the same or equivalent functions may be accomplished by different embodiments that are intended to be encompassed within the spirit and scope of the present application.

While operations are depicted in the drawings in a particular order, persons skilled in the art will readily recognize that such operations need not be performed in the particular order shown or in sequential order, or that among all illustrated operations to be performed, to achieve desirable results, sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present application, examples of which are illustrated in the accompanying drawings. To facilitate understanding, embodiments are provided under specific network architecture and new service scenarios, such as 3rd generation partnership project (3GPP) long term evolution (LTE), LTE-advanced, fifth generation (5G) (i.e., new radio (NR)), 5G-advanced, sixth generation (6G), and so on. Persons skilled in the art know very well that, with the development of network architecture and new service scenarios, the embodiments in the present application are also applicable to similar technical problems; and moreover, the terminologies recited in the present application may change, which should not affect the principle of the present application.

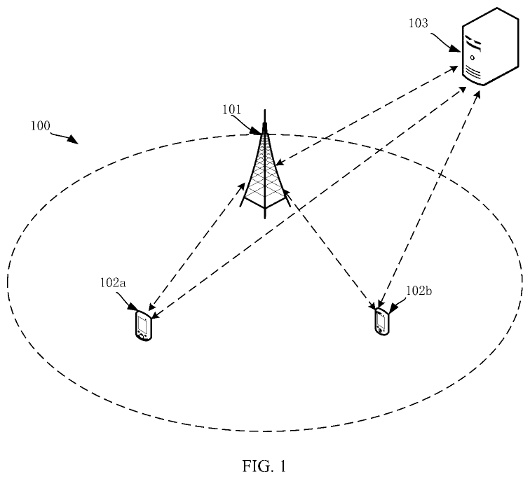

FIG. 1 is a schematic diagram illustrating an exemplary wireless communication system 100 according to some embodiments of the present application.

As shown in FIG. 1, the wireless communication system 100 includes at least one BS 101, at least one UE (e.g., a UE 102a and a UE 102b), and at least one LMF 103. Although one BS, two UEs, and one LMF are depicted in FIG. 1 for illustrative purpose, it is contemplated that any number of BSs, UEs, and LMFs may be included in the wireless communication system 100.

The wireless communication system 100 is compatible with any type of network that is capable of sending and receiving wireless communication signals. For example, the wireless communication system 100 is compatible with a wireless communication network, a cellular telephone network, a time division multiple access (TDMA) based network, a code division multiple access (CDMA) based network, an orthogonal frequency division multiple access (OFDMA) based network, an LTE network, a 3GPP-based network, a 3GPP 5G network, a satellite communications network, a high-altitude platform network, and/or other communications networks.

The BS 101 may be an access point, an access terminal, a radio access network (RAN) node, a TRP, a base station, a next generation (NG) RAN node, a node-B, an enhanced node B (eNB), a next generation node B (gNB), a home node-B, a relay node, or a device, or described using other terminology used in the art. The BS 101 is generally part of a RAN that may include a controller communicably coupled to the BS 101.

According to some embodiments of the present application, the UE 102a and the UE 102b may include vehicle UEs (VUEs) and/or power-saving UEs (also referred to as power sensitive UEs). The power-saving UEs may include vulnerable road users (VRUs), public safety UEs (PS-UEs), and/or commercial sidelink UEs (CS-UEs) that are sensitive to power consumption. In an embodiment of the present application, a VRU may include a pedestrian UE (P-UE), a cyclist UE, a wheelchair UE or other UEs which require power saving compared with a VUE. In an embodiment of the present application, the UE 102a may be a power-saving UE and the UE 102b may be a VUE. In another embodiment of the present application, both the UE 102a and the UE 102b may be VUEs or power-saving UEs.

According to some other embodiments of the present application, the UE 102a and the UE 102b may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some other embodiments of the present application, the UE 102a and the UE 102b may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the present application, the UE 102a and the UE 102b may include wearable devices, such as smart watches, fitness bands, optical head-mounted displays, or the like.

Moreover, a UE may be referred to as a subscriber unit, a mobile, a mobile station, a user, a terminal, a mobile terminal, a wireless terminal, a fixed terminal, a subscriber station, a user terminal, or a device, or described using other terminology used in the art.

Both the UE 102a and the UE 102b in the embodiments of FIG. 1 are in a coverage area of the BS 101, and may transmit information or data to the BS 101 and receive control information or data from the BS 101, for example, via LTE or NR Uu interface.

The LMF 103 (also referred to as LMF entity) may refer to a network element or network entity for supporting location services, which may be deployed in a core network (CN) or in a RAN of the wireless communication system 100. The LMF 103 may communicate with the BS 101 via NR positioning protocol A (NRPPa) signaling, and may communicate with the UE 102a or UE 102b via LTE positioning protocol (LPP) signaling.

A wireless communication system may support both radio access technology (RAT) independent positioning and RAT-dependent positioning for a UE. The RAT-independent positioning means that the positioning is not related to the reference signal(s) in Uu interface, and may include wireless local area network (WLAN) positioning, Bluetooth positioning, global navigation satellite system (GNSS) positioning, etc. The RAT-dependent positioning means that the UE's position is calculated based on reference signal (e.g., SRS, PRS, and/or other reference signal) measurement(s) in Uu interface. The RAT-dependent positioning may include various positioning methods, e.g., an enhanced cell identity (E-CID) positioning method, a multi-roundtrip time (multi-RTT) positioning method, a DL angle of departure (AoD) positioning method, a DL time difference of arrival (TDoA) positioning method, a UL-TDoA positioning method, a UL angle-of-arrival (AoA) positioning method, etc.

The RAT-dependent positioning may involve a UE (e.g., a target UE whose position needs to be known), NG-RAN node(s) (e.g., BS(s) and TRP(s)), and an LMF. In some examples, an NG-RAN node and the LMF may exchange position related information via NRPPa signaling. The UE and the LMF may exchange position related information via LPP signaling. The UE may receive positioning related configurations from an NG-RAN node via radio resource control (RRC) signaling.

DL PRS is the main reference signal for supporting DL-based positioning methods (e.g., DL-TDoA, DL-AOD, etc.), while SRS is the main reference signal for supporting UL-based positioning methods (e.g., UL-TDoA, UL-AoA, etc.).

In some examples, when an LMF determines a positioning method for a UE which requires measurements from the UE, the LMF may interact with the UE to support the positioning method. Then, the LMF may request a BS to configure a PRS configuration for the UE and the BS may respond with the PRS configuration to the LMF. Then, the LMF may send the PRS configuration to the UE through an assistance data transfer procedure. In an example, to reduce signaling cost, an on-demand PRS transmission procedure may be initiated either by the UE or the LMF to allow the LMF to control and decide whether PRS is transmitted or not and to change the characteristics of an ongoing PRS transmission.

In some examples, when an LMF determines a positioning method for a UE, which requires measurements from a BS, the LMF may interact with the BS to support the positioning method. Then, the LMF may request the BS to configure an SRS configuration for the UE and the BS may respond with the SRS configuration to the LMF. In an example, the BS may provide an updated SRS configuration to the LMF when the SRS configuration changes. In an example, if semi-persistent or aperiodic SRS is configured to the UE, the LMF may activate or deactivate the SRS transmission. When the SRS is transmitted by the UE, the LMF may request multiple TRPs to perform UL measurements and report measurement results. In such examples, the BS may serve several TRPs, including for example remote radio heads, UL-SRS only receive points (RPs), DL-PRS-only transmit points (TPs), etc.

Both PRS and SRS may be designed to cover the full bandwidth, where the resource elements are spread across different symbols so as to cover all subcarriers. In addition, SRS is also designed with a comb-based pattern similar to PRS. The configurations and transmissions of PRS and SRS are very similar, and thus the following examples describe configurations and transmissions of PRS for illustrative purposes. For example, PRS may be transmitted by different BSs (e.g., the serving BS and one or more neighboring BSs) using narrow beams over frequency range 1 (FR1, 450 MHz~6,000 MHz) and frequency range 1 (FR2, 24,250 MHz~52,600 MHz), and may be transmitted across the whole cell. The PRS may be associated with a PRS resource set ID and a resource ID for a BS per TRP. In an example, UE positioning measurements such as reference signal time difference (RSTD) and PRS RSRP measurements may be made between beams (e.g., between a different pair of DL PRS resources or a different pair of DL PRS resource sets).

The adoption of millimeter-wave (mmWave) and terahertz technologies guarantees higher available bandwidths, which may bring higher positioning accuracies. However, it also brings new challenges in terms of coverage and reliability because signals may be blocked by obstacles and multipath may not be sufficient to guarantee a suitable coverage in non-line-of-sight (NLoS) channel conditions. Moreover, the positioning accuracy may also be limited by locations of BSs, a number of BSs, and availability of line-of-sight (LoS).

A promising technology to solve the above problems is a RIS technology, which has the ability to actively customize the radio environment for a wireless system, e.g., the beyond 5G (B5G) system or 6G system. Specifically, a RIS may be a planar surface including many reflecting elements (herein also referred to as RIS elements or elements), and can be deployed on the surfaces of various objects such as walls. The reflection coefficients of the RIS may be adjusted by changing the states of the elements of the RIS. Compared with deploying BSs, deploying RISs is more flexible, and the cost is lower. With the assistance of RISs, wireless networks can obtain a higher spatial resolution and positioning accuracy.

Although RIS is a promising technology to improve the positioning accuracy for wireless networks, the procedures for RIS-assisted positioning have not been discussed yet. For example, during a legacy RAT-dependent positioning procedure (e.g., no RIS-assisted positioning), when there exists limited TRPs, limited known location information of TRPs, or weak signal quality, or the calculated positioning result cannot satisfy QoS requirements, how RISs assist to complete the positioning procedure and improve the accuracy of the calculated positioning result needs to be further studied.

Given the above, embodiments of the present application propose solutions for RIS-assisted positioning (e.g., RIS-assisted RAT-dependent positioning). For example, embodiments of the present application propose solutions regarding trigger conditions for RIS-assisted positioning, determination of available RIS(s) for RIS-assisted positioning, PRS configuration and corresponding transfer procedures for RIS-assisted positioning, or SRS configuration and corresponding transfer procedures for RIS-assisted positioning. More details on embodiments of the present application will be described in the following text in combination with the appended drawings.

According to some embodiments of the present application, RISs may be deployed in a RAN to enhance a link between a BS and a UE.

In some embodiments, a RIS may be deployed as a radio node similar to a BS or similar to a UE, or a totally new radio node in the network.

In some embodiments, the air interface between a BS and a RIS may be a known interface, e.g., a Uu interface if the RIS is deployed as a radio node similar to a UE or an Xn interface if the RIS is deployed as a radio node similar to a BS. In some embodiments, the air interface between a BS and a RIS may be a newly defined interface if the RIS is deployed as a totally new radio node in the network.

In some embodiments, the air interface between a UE and a RIS may be a known interface, e.g., a PC5 interface if the RIS is deployed as a radio node similar to a UE or a Uu interface if the RIS is deployed as a radio node similar to a BS. In some embodiments, the air interface between a UE and a RIS may be a newly defined interface if the RIS is deployed as a totally new radio node in the network.

In some embodiments, the air interface between an access and mobility management function (AMF) and a RIS may be a known interface, e.g., an NG interface if the RIS is deployed as a radio node similar to a BS. In some embodiments, the air interface between an AMF and a RIS may be a newly defined interface if the RIS is deployed as a totally new radio node in the network.

In some embodiments, the RIS may be fully controlled by a BS or a UE via the above air interfaces.

In some embodiments, a BS or a UE may transmit, to a RIS, control information for the RIS. The control information may indicate the RIS to tune coefficients and properties of elements of the RIS, indicate the RIS to receive signals from the network, or reconfigure the coefficients of the elements of the RIS, etc.

The RIS-assisted positioning may include RIS-assisted DL positioning and RIS-assisted UL positioning. The following Embodiment 1 provide solutions regarding trigger condition(s) for RIS-assisted DL positioning, determination of available RIS(s) for RIS-assisted DL positioning, PRS configuration and corresponding transfer procedure for RIS-assisted DL positioning, etc. The following Embodiment 2 provide solutions regarding trigger condition(s) for RIS-assisted UL positioning, determination of available RIS(s) for RIS-assisted UL positioning, SRS configuration and corresponding transfer procedure for RIS-assisted UL positioning, etc.

### Embodiment 1

According to some embodiments of the present application, before initiating a RIS-assisted DL positioning, a positioning system may perform a RAT-dependent DL positioning procedure with no RIS assisting. For example, when there is a location service request from a UE (e.g., mobile originated location request (MO-LR)) or from a network (e.g., mobile terminated location request (MT-LR)), an AMF may determine whether there is available RIS(s) in the positioning system. If there is no available RIS(s), an LMF, a BS, and the UE may continue a capability information transfer procedure as specified in 3GPP standard documents and subsequent procedures for DL positioning with no RIS assisting. If there is available RIS(s), the LMF, the BS, and the UE may also continue a capability information transfer procedure, but the LMF may initiate a RIS-assisted DL positioning when certain conditions occur.

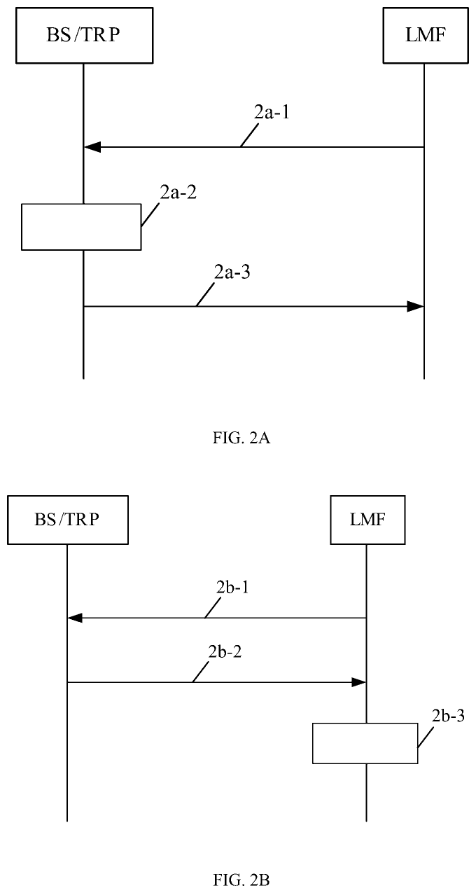

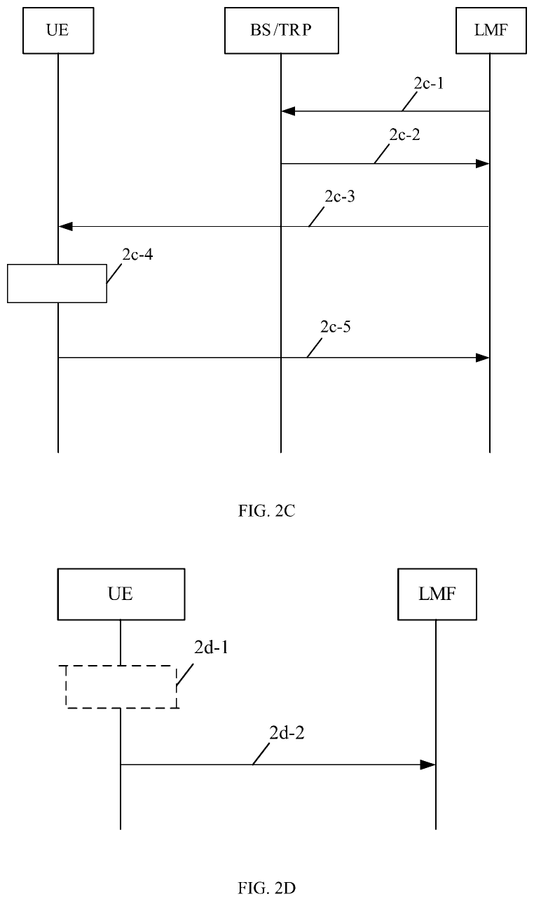

In Embodiment 1, an LMF may determine to initiate a RIS-assisted DL positioning based on at least one of assistance data or measurement results from at least one of a BS or a UE. FIGS. 2A-2D illustrate exemplary methods for initiating a RIS-assisted DL positioning according to some embodiments of the present application.

The method illustrated in FIG. 2A may be performed by at least two network entities, e.g., a BS (or a TRP) and an LMF. Although the method is illustrated in a system level, persons skilled in the art can understand that the method implemented in the two network entities can be separately implemented and incorporated in other apparatus with the like functions.

Referring to FIG. 2A, in step 2a-1, the LMF may transmit a TRP information request message (e.g., which is an NRPPa message) to the BS. Before, after, or simultaneously with step 2a-1, the BS may configure (or pre-configure) a minimum number of TRPs (e.g., a threshold) based on QoS requirements of a positioning service. In response to receiving the TRP information request message, in step 2a-2, the BS may compare a number of candidate TRPs with the minimum number of TRPs. In response to that the number of candidate TRPs is less than the minimum number of TRPs, in step 2a-3, the BS may transmit, to the LMF, an indication indicating to initiate the RIS-assisted DL positioning. In an embodiment, the indication may be a RIS-assisted positioning request message (e.g., which is an NRPPa message). In another embodiment, the indication (e.g., a flag) may be transmitted in a TRP information response message (e.g., which is an NRPPa message) from the BS to the LMF. For example, the indication may be a 1-bit indication with a value indicating to initiate the RIS-assisted DL positioning. Consequently, in step 2a-3, the LMF may receive the indication from the BS. Then, the LMF may determine to initiate the RIS-assisted DL positioning in response to receiving the indication.

The method illustrated in FIG. 2B may be performed by at least two network entities, e.g., a BS (or a TRP) and an LMF. Although the method is illustrated in a system level, persons skilled in the art can understand that the method implemented in the two network entities can be separately implemented and incorporated in other apparatus with the like functions.

Referring to FIG. 2B, in step 2b-1, the LMF may transmit a TRP information request message (e.g., which is an NRPPa message) to the BS. Before, after, or simultaneously with step 2a-1, the BS may configure (or pre-configure) a minimum number of TRPs (e.g., a threshold) based on QoS requirements of a positioning service. In response to receiving the TRP information request message, in step 2b-2, the BS may transmit a TRP information response message (e.g., which is an NRPPa message) indicating the minimum number of TRPs and a number of candidate TRPs to the LMF. In response to receiving the TRP information response message, in step 2b-3, the LMF may compare the number of candidate TRPs with the minimum number of TRPs. In response to that the number of candidate TRPs is less than the minimum number of TRPs, the LMF may determine to initiate the RIS-assisted DL positioning.

The method illustrated in FIG. 2C may be performed by at least three network entities, e.g., a UE, a BS (or a TRP), and an LMF. The UE may be a target UE whose position needs to be known. Although the method is illustrated in a system level, persons skilled in the art can understand that the method implemented in the three network entities can be separately implemented and incorporated in other apparatus with the like functions.

Referring to FIG. 2C, in step 2c-1, the LMF may transmit a TRP information request message (e.g., which is an NRPPa message) to the BS. Before, after, or simultaneously with step 2c-1, the BS may configure (or pre-configure) a minimum number of TRPs (e.g., a threshold) based on QoS requirements of a positioning service. In response to receiving the TRP information request message, in step 2c-2, the BS may transmit a TRP information response message (e.g., which is an NRPPa message) indicating the minimum number of TRPs and a number of candidate TRPs to the LMF.

In response to receiving the TRP information response message, in step 2c-3, the LMF may transmit a provide assistance data message (e.g., which is an LPP message) indicating the minimum number of TRPs configured or pre-configured by the BS and the number of candidate TRPs to the UE. In response to receiving the provide assistance data message, in step 2c-4, the UE may compare the number of candidate TRPs with the minimum number of TRPs. In response to that the number of candidate TRPs is less than the minimum number of TRPs, in step 2c-5, the UE may transmit, to the LMF, an indication indicating to initiate the RIS-assisted DL positioning. In an embodiment, the indication may be a RIS-assisted positioning request message (e.g., which is an LPP message). In another embodiment, the indication (e.g., a flag) may be transmitted in a provide location information message (e.g., which is an LPP message) from the UE to the LMF. For example, the indication may be a 1-bit indication with a value indicating to initiate the RIS-assisted DL positioning. Consequently, in step 2c-5, the LMF may receive the indication from the UE. Then, the LMF may determine to initiate the RIS-assisted DL positioning in response to receiving the indication.

The method illustrated in FIG. 2D may be performed by at least two network entities, e.g., a UE and an LMF. The UE may be a target UE whose position needs to be known. Although the method is illustrated in a system level, persons skilled in the art can understand that the method implemented in the two network entities can be separately implemented and incorporated in other apparatus with the like functions.

In some examples, the UE may configure (or pre-configure) an RSRP threshold. Referring to FIG. 2D, in step 2d-1, the UE may compare a measured RSRP value with the RSRP threshold or compare a calculated positioning result with QoS requirements. Step 2d-1 is an optional step and may be not performed by the UE.

In response to that the measured RSRP value is less than the RSRP threshold or the calculated positioning result is not satisfied with QoS requirements, in step 2d-2, the UE may transmit an indication indicating to initiate the RIS-assisted DL positioning to an LMF. In an embodiment, the indication may be a RIS-assisted positioning request message (e.g., which is an LPP message). In another embodiment, the indication (e.g., a flag) may be transmitted in a provide location information message (e.g., which is an LPP message) from the UE to the LMF. For example, the indication may be a 1-bit indication with a value indicating to initiate the RIS-assisted DL positioning. Consequently, in step 2d-2, the LMF may receive the indication from the UE. Then, the LMF may determine to initiate the RIS-assisted DL positioning in response to receiving the indication.

It is contemplated that any one of the methods illustrated in FIGS. 2A-2D or any combination thereof may be performed to initiate the RIS-assisted DL positioning.

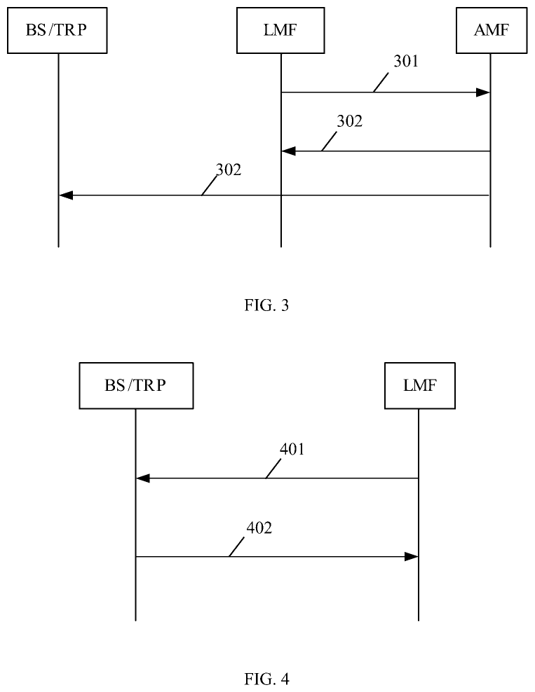

After the LMF determines to initiate the RIS-assisted DL positioning, available RIS(s) for the RIS-assisted DL positioning may be determined. FIG. 3 illustrates an exemplary procedure for determining available RIS(s) according to some embodiments of the present application. The procedure illustrated in FIG. 3 may be performed by at least three network entities, e.g., a BS (or a TRP), an LMF, and an AMF. Although the method is illustrated in a system level, persons skilled in the art can understand that the method implemented in the three network entities can be separately implemented and incorporated in other apparatus with the like functions.

Referring to FIG. 3, in response to determining to initiate the RIS-assisted DL positioning, in step 301, the LMF may transmit a request message for requesting available RIS(s) to the AMF. In response to receiving the request message, the AMF may select (or determine) available RIS(s) for the RIS-assisted DL positioning. Then, in step 302, the AMF may transmit information of the available RIS(s) to the BS and to the LMF. In some embodiments, the information of the available RIS(s) includes at least one of: location(s) of the available RIS(s) or a number of elements of each available RIS.

After determining available RIS(s) for the RIS-assisted DL positioning, the LMF may obtain capability information of the available RIS(s). FIG. 4 illustrates an exemplary procedure for obtaining capability information of available RIS(s) according to some embodiments of the present application. The method illustrated in FIG. 4 may be performed by at least two network entities, e.g., a BS (or a TRP) and an LMF. Although the method is illustrated in a system level, persons skilled in the art can understand that the method implemented in the two network entities can be separately implemented and incorporated in other apparatus with the like functions.

Referring to FIG. 4, in response to receiving information of the available RIS(s) from the AMF, in step 401, the LMF may transmit a RIS capability request message requesting capability information of the available RIS(s) to the BS. In response to receiving the RIS capability request message, in step 402, the BS may transmit the capability information of the available RIS(s) to the LMF. In some embodiments, the capability information includes capability of tuning coefficients and properties of RIS element(s) included in each of the available RIS(s) according to control information from the BS.

In some embodiments, after receiving information of the available RIS(s) from the AMF, the BS may transmit the capability information of the available RIS(s) to the LMF without a request from the LMF.

After determining the available RIS(s), the BS may configure a PRS configuration for the RIS-assisted DL positioning. When configuring the PRS configuration, how to distinguish the PRS of a direct link from a BS to a UE (e.g., target UE) and the PRS of a cascade link including a link from the BS to a RIS and a link from the RIS to the UE when the direct link and the cascade link using the same resource set and resource ID in the same layer needs to be solved. The following embodiments provide solutions regarding PRS configuration to solve the above problem and the corresponding PRS configuration transfer procedure.

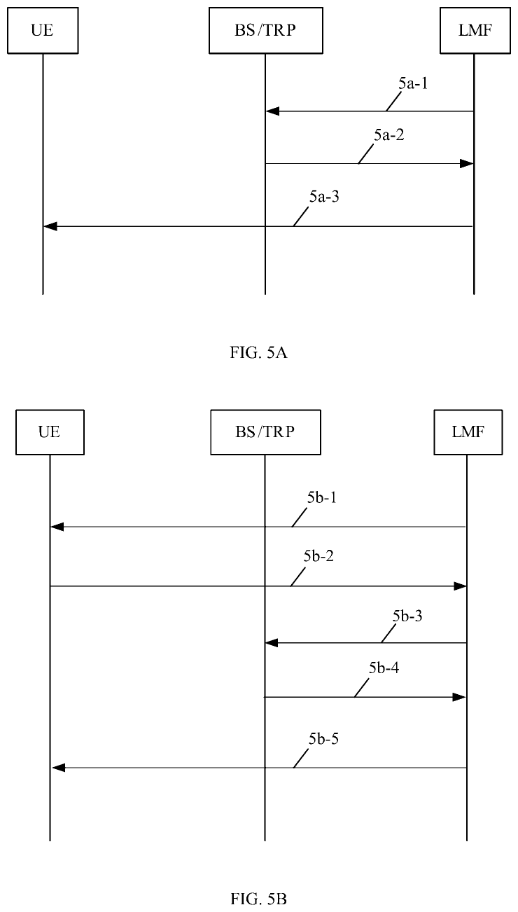

FIGS. 5A and 5B illustrate exemplary PRS configuration transfer procedures according to some embodiments of the present application.

The methods illustrated in FIGS. 5A and 5B may be performed by at least three network entities, e.g., a UE, a BS (or a TRP) and an LMF. The UE may be a target UE whose position needs to be known. Although the method is illustrated in a system level, persons skilled in the art can understand that the method implemented in the three network entities can be separately implemented and incorporated in other apparatus with the like functions.

Referring to FIG. 5A, after receiving the capability information of the available RIS(s), in step 5a-1, the LMF may transmit a request message (e.g., which is an NRPPa message) requesting PRS configuration(s) to the BS. The PRS configuration(s) may include a PRS configuration (e.g., denoted as DL-PRS configuration) for a direct link from the BS to the UE and a PRS configuration (e.g., denoted as DL-PRS-RIS configuration) for a cascade link including a link from the BS to a RIS and a link from the RIS to the UE. In response to receiving the request message, the BS may configure the PRS configuration(s), e.g., the DL-PRS configuration and the DL-PRS-RIS configuration. Then, in step 5a-2, the BS may transmit the DL-PRS configuration and the DL-PRS-RIS configuration to the LMF, e.g., via an NRPPa message. For example, the PRS configuration(s) may be successfully configured or updated PRS configuration(s). In step 5a-3, the LMF may transmit the PRS configuration(s) (e.g., the DL-PRS configuration and the DL-PRS-RIS configuration) to the UE, e.g., via a provide assistance data message (e.g., which is an LPP message) to the UE.

Referring to FIG. 5B, after receiving the capability information of the available RIS(s), in step 5b-1, the LMF may transmit the capability information of the available RIS(s) to the UE, e.g., via an LPP message. In step 5b-2, the UE may transmit an on-demand PRS request message (e.g., which is an LPP message) for the RIS-assisted DL positioning to the LMF. Based on the on-demand PRS request message, in step 5b-3, the LMF may transmit a request message (e.g., which is an NRPPa message) requesting PRS configuration(s) to the BS. The PRS configuration(s) may include a DL-PRS configuration for a direct link from the BS to the UE and a DL-PRS-RIS configuration for a cascade link including a link from the BS to a RIS and a link from the RIS to the UE. In response to receiving the request message, the BS may configure the PRS configuration(s), e.g., the DL-PRS configuration and the DL-PRS-RIS configuration. Then, in step 5b-4, the BS may transmit the DL-PRS configuration and the DL-PRS-RIS configuration to the LMF, e.g., via an NRPPa message. For example, the PRS configuration(s) may be successfully configured or updated PRS configuration(s). In step 5b-5, the LMF may transmit the PRS configuration(s) (e.g., the DL-PRS configuration and the DL-PRS-RIS configuration) to the UE, e.g., via a provide assistance data message (e.g., which is an LPP message) to the UE.

In some embodiments, a DL-PRS-RIS configuration for a cascade link may indicate (e.g., include) a first list (e.g., defined by information element (IE) nr-DL-PRS-RIS-ResourceSetList) of DL PRS resource sets per TRP in each frequency layer. A DL-PRS configuration for a direct link may indicate (e.g., include) a second list (e.g., defined by IE nr-DL-PRS-ResourceSetList) of DL PRS resource sets which is configured per TRP in each frequency layer. In such embodiments, DL PRS resource set(s) included in the first list is different from DL PRS resource set(s) included in the second list. For example, a DL PRS resource set included in the second list may be defined by IE NR-DL-PRS-ResourceSet as specified in 3GPP standard documents while a DL PRS resource set included in the first list may be defined by IE NR-DL-PRS-RIS-ResourceSet.

For example, it is assumed that the maximum number of DL PRS resource sets configured per TRP in each frequency layer is denoted as nrMaxSetsPerTrpPerFreqLayer, then:

| | |
|---|---|
| nr-DL-PRS-RIS-ResourceSetList | may be defined as |
| nr-DL-PRS-RIS-ResourceSetList ::= | SEQUENCE (SIZE(1 . . . N1)) OF |
| NR-DL-PRS-RIS-ResourceSetList; and | |

```
  nr-DL-PRS-RIS-ResourceSetList may be defined as: nr-DL-PRS-RIS-ResourceSetList ::=
  SEQUENCE  (SIZE  (N1+1 . . . nrMaxSetsPerTrpPerFreqLayer))  OF
  NR-DL-PRS-ResourceSet;
```

wherein N1 is the number of DL PRS resource sets included in the first list and 1≤N1≤nrMaxSetsPerTrpPerFreqLayer. The above example means that the first list includes first N1 DL PRS resource sets included in the maximum number of DL PRS resource sets, and the second list includes the remaining (nrMaxSetsPerTrpPerFreqLayer-N1) DL PRS resource sets included in the maximum number of DL PRS resource sets.

In some embodiments, NR-DL-PRS-RIS-ResourceSet may include parameters (also referred to as IEs) with definitions similar to those included in NR-DL-PRS-ResourceSet as specified in 3GPP standard documents.

For example, each DL PRS resource set included in the first list may be defined by a set of parameters including at least one of:
a first parameter (e.g., denoted as nr-DL-PRS-RIS-ResourceSetID) indicating an ID of the DL PRS resource set;
a second parameter (e.g., denoted as dl-PRS-RIS-Periodicity-and-ResourceSetSlotOffset) indicating a periodicity and an offset for the DL PRS resource set;
a third parameter (e.g., denoted as dl-PRS-RIS-ResourceRepetitionFactor) indicating how many times each DL PRS resource is repeated for a single instance of the DL PRS resource set;
a fourth parameter (e.g., denoted as dl-PRS-RIS-ResourceTimeGap) indicating an offset between two repeated instances of a DL PRS resource;
a fifth parameter (e.g., denoted as dl-PRS-RIS-NumSymbols) indicating a number of symbols of a DL PRS resource within a slot;
a sixth parameter (e.g., denoted as dl-PRS-RIS-ResourcePower) indicating an average energy per resource element of the resources elements that carry PRS; or
a seventh parameter (e.g., denoted as dl-PRS-RIS-ResourceList) indicating a set of DL PRS resources.

In other words, NR-DL-PRS-RIS-ResourceSet may include at least one of the above parameters. In addition to the above parameters, NR-DL-PRS-RIS-ResourceSet may include other parameters with definitions similar to those included in NR-DL-PRS-ResourceSet as specified in 3GPP standard documents.

In some embodiments of the present application, after the PRS configuration transfer procedure, the BS may adjust coefficients of element(s) in an available RIS. For example, first, the BS may randomly select coefficients for element(s) in the available RIS. Then, the BS may transmit, to a UE (e.g., a target UE whose position needs to be known), reference signals via a cascade link including a link from the BS to the available RIS and a link from the available RIS to the UE. Based on the reference signals, the UE may determine a CSI report and transmit the CSI report of the cascade link to the BS. Then, the BS may tune the coefficients for element(s) in the available RIS based on the CSI report. In some examples, once the available RIS is enabled, the cascaded link may be estimated to derive the optimal reflecting coefficients of element(s) in the available RIS for the UE.

In some embodiments of the present application, for the RIS-assisted DL positioning, the UE or the LMF may calculate a positioning result of the UE.

FIG. 6 illustrates an exemplary procedure for calculating a positioning result of a UE based on a RIS-assisted DL positioning according to some embodiments of the present application. The method illustrated in FIG. 6 may be performed by at least two network entities, e.g., a UE and an LMF. Although the method is illustrated in a system level, persons skilled in the art can understand that the method implemented in the two network entities can be separately implemented and incorporated in other apparatus with the like functions.

In the embodiments of FIG. 6, the UE may receive PRS(s) transmitted by a BS. The PRS(s) may be transmitted by the BS and received by the UE based on the PRS configuration(s) (e.g., DL-PRS configuration and DL-PRS-RIS configuration) configured by the BS as described above.

Referring to FIG. 6, in step 601, the LMF may transmit a request location information message (e.g., which is an LPP message) to the UE. In response to receiving the request location information message, in step 602, the UE may measure PRS(s) on a direct link from the BS to the UE and PRS(s) on a cascade link including a link from the BS to a RIS and a link from the RIS to the UE. Then, for the UE-based positioning (i.e., the positioning result is calculated by the UE), step 603 may be performed. In step 603, the UE may calculate a positioning result of the UE based on PRS measurement results of the direct link and the cascade link. Alternatively, for the LMF-based positioning (i.e., the positioning result is calculated by the LMF), steps 604a and 604b may be performed. In step 604a, the UE may transmit the PRS measurement results of the direct link and the cascade link to the LMF in a provide location information message (e.g., which is an LPP message). Then, in step 604b, the LMF may calculate a positioning result of the UE based at least in part on the PRS measurement results.

### Embodiment 2

According to some embodiments of the present application, before initiating a RIS-assisted UL positioning, a positioning system may perform a RAT-dependent UL positioning procedure with no RIS assisting. For example, when there is a location service request from a UE (e.g., mobile originated location request (MO-LR)) or from a network (e.g., mobile terminated location request (MT-LR)), an AMF may determine whether there is available RIS(s) in the positioning system. If there is no available RIS(s), an LMF, a BS, and the UE may continue a capability information transfer procedure as specified in 3GPP standard documents and subsequent procedures for UL positioning with no RIS assisting. If there is available RIS(s), the LMF, the BS, and the UE may also continue a capability information transfer procedure, but the LMF may initiate a RIS-assisted UL positioning when certain conditions occur.

In Embodiment 2, an LMF may determine to initiate a RIS-assisted UL positioning based on assistance data from a BS. In some embodiments, the methods for initiating a RIS-assisted DL positioning as illustrated in FIGS. 2A and 2B may also apply for the LMF to initiate a RIS-assisted UL positioning, and details thereof are omitted here for simplification.

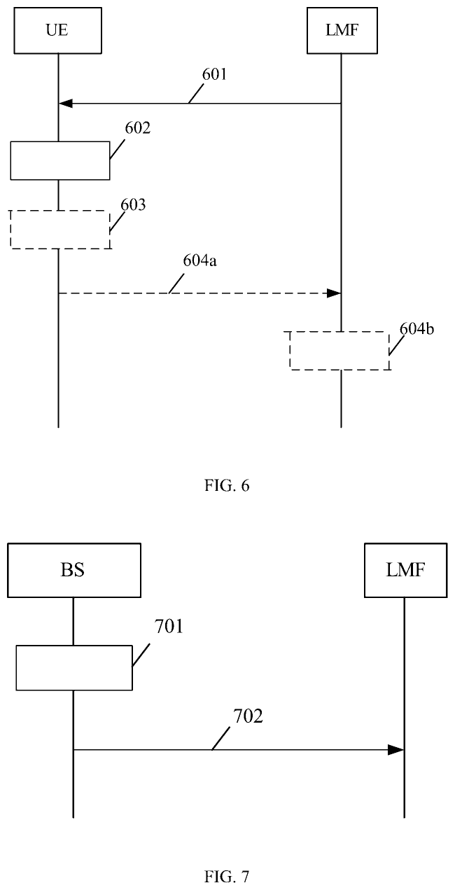

FIG. 7 illustrates another exemplary method for initiating a RIS-assisted UL positioning according to some embodiments of the present application. The method illustrated in FIG. 7 may be performed by at least two network entities, e.g., a BS (or a TRP) and an LMF. Although the method is illustrated in a system level, persons skilled in the art can understand that the method implemented in the two network entities can be separately implemented and incorporated in other apparatus with the like functions.

In some examples, the BS may configure (or pre-configure) an RSRP threshold. Referring to FIG. 7, in step 701, the BS may compare a measured RSRP value with the RSRP threshold. In response to that the measured RSRP value is less than the RSRP threshold, in step 702, the BS may transmit an indication indicating to initiate the RIS-assisted UL positioning to the LMF. In an embodiment, the indication may be a RIS-assisted positioning request message (e.g., which is an NRPPa message). In another embodiment, the indication (e.g., a flag) may be transmitted in a measurement response message (e.g., which is an NRPPa message) from the BS to the LMF. For example, the indication may be a 1-bit indication with a value indicating to initiate the RIS-assisted UL positioning. Consequently, in step 702, the LMF may receive the indication from the BS. Then, the LMF may determine to initiate the RIS-assisted UL positioning in response to receiving the indication.

It is contemplated that any one of the methods illustrated in FIGS. 2A, 2B, and 7 or any combination thereof may be performed to initiate the RIS-assisted UL positioning.

After the LMF determines to initiate the RIS-assisted UL positioning, available RIS(s) for the RIS-assisted UL positioning may be determined. The method as shown in FIG. 3 may also apply for determining available RIS(s) for the RIS-assisted UL positioning, and details thereof are omitted here for simplification.

After determining available RIS(s) for the RIS-assisted UL positioning, the LMF may obtain the capability information of the available RIS(s). The method as shown in FIG. 4 may also apply for obtaining capability information of available RIS(s) for the RIS-assisted UL positioning, and details thereof are omitted here for simplification.

After determining the available RIS(s), the BS may configure an SRS configuration for the RIS-assisted UL positioning. When configuring the SRS configuration, how to distinguish the SRS of a direct link from a UE (e.g., target UE) to a BS and the SRS of a cascade link including a link from the UE to a RIS and a link from the RIS to the BS when the direct link and the cascade link using the same resource set and resource ID in the same layer needs to be solved. The following embodiments provide solutions regarding SRS configuration to solve the above problem and the corresponding SRS configuration transfer procedure.

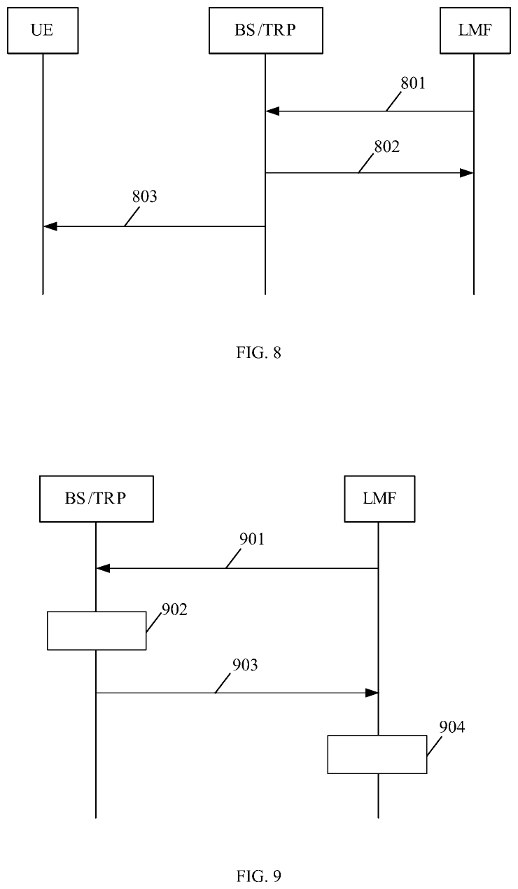

FIG. 8 illustrates an exemplary SRS configuration transfer procedure according to some embodiments of the present application.

The method illustrated in FIG. 8 may be performed by at least three network entities, e.g., a UE, a BS (or a TRP) and an LMF. The UE may be a target UE whose position needs to be known. Although the method is illustrated in a system level, persons skilled in the art can understand that the method implemented in the three network entities can be separately implemented and incorporated in other apparatus with the like functions.

Referring to FIG. 8, after receiving the capability information of the available RIS(s), in step 801, the LMF may transmit a request message (e.g., which is an NRPPa message) requesting SRS configuration(s) to the BS.

In some embodiments of FIG. 8, the request message requesting the SRS configuration(s) may be a positioning information request message and the SRS configuration(s) may include an SRS configuration (e.g., denoted as UL-SRS configuration) for a direct link from the UE to the BS and an SRS configuration (e.g., denoted as UL-SRS-RIS configuration) for a cascade link including a link from the UE to a RIS and a link from the RIS to the BS

In response to receiving the request message in step 801, the BS may configure the UL-SRS configuration and the UL-SRS-RIS configuration. Then, in step 802, the BS may transmit the SRS configuration(s) (e.g., the UL-SRS configuration and the UL-SRS-RIS configuration) in a positioning information response message (e.g., which is an NRPPa message) to the LMF. In step 803, the BS may also transmit the SRS configuration(s) (e.g., the UL-SRS configuration and the UL-SRS-RIS configuration) to the UE, e.g., via an RRC message. Step 803 may occur before, after, or simultaneously with step 802.

In some other embodiments of FIG. 8, semi-persistent or aperiodic SRS is configured. In such embodiments, the request message requesting the SRS configuration(s) may be a positioning activation request message and the SRS configuration(s) may include a UL-SRS configuration for a direct link from the UE to the BS and a UL-SRS-RIS configuration for a cascade link including a link from the UE to a RIS and a link from the RIS to the BS.

In such embodiments, the positioning activation request message may active an SRS transmission for the direct link and an SRS transmission for the cascade link and request the UL-SRS configuration and the UL-SRS-RIS configuration.

In response to receiving the positioning activation request message in step 801, the BS may configure the UL-SRS configuration and the UL-SRS-RIS configuration. Then, in step 802, the BS may transmit the SRS configuration(s) (e.g., the UL-SRS configuration and the UL-SRS-RIS configuration) in a positioning information response message (e.g., which is an NRPPa message) to the LMF. In step 803, the BS may transmit the SRS configuration(s) (e.g., the UL-SRS configuration and the UL-SRS-RIS configuration) to the UE, e.g., via an RRC message. In step 803, the BS may also activate the SRS transmission for the direct link and the SRS transmission for the cascade link. Step 803 may occur before, after, or simultaneously with step 802.

In some embodiments, a UL-SRS-RIS configuration for a cascade link may indicate (e.g., include) at least one of a first list (e.g., defined by IE srs-RIS-PosResourceSetToReleaseList) of SRS positioning resource sets to be released or a second list (e.g., defined by IE srs-RIS-PosResourceSetToAddModList) of SRS positioning resource sets to be added or modified. A UL-SRS configuration for a direct link may indicate (e.g., include) at least one of a third list (e.g., defined by IE srs-PosResourceSetToReleaseList) of SRS positioning resource sets to be released or a fourth list (e.g., defined by srs-PosResourceSetToAddModList) of SRS positioning resource sets to be added or modified. SRS positioning resource set(s) included in the first list is different from SRS positioning resource set(s) included in the third list. SRS positioning resource set(s) included in the second list is different from SRS positioning resource set(s) included in the fourth list. For example, an SRS positioning resource set included in the third list or the fourth list may be defined by IE srs-PosResourceSet as specified in 3GPP standard documents and an SRS positioning resource set included in the first list or the second list may be defined by IE srs-RIS-PosResourceSet.

As an example, it is assumed that the maximum number of SRS positioning resource sets configured per UL bandwidth part (BWP) is denoted as maxNrofSRS-PosResourceSets, then:

| | |
|---|---|
| srs-RIS-PosResourceSetToReleaseList | may be defined as |
| srs-RIS-PosResourceSetToReleaseList ::= | SEQUENCE (SIZE(1 . . . N2)) OF |
| srs-RIS-PosResourceSet; and | |
| srs-PosResourceSetToReleaseList | may be defined as: |
| srs-PosResourceSetToReleaseList | ::= SEQUENCE (SIZE |

(N2+1 . . . maxNrofSRS-PosResourceSets)) OF srs-PosResourceSet;

wherein N2 is the number of SRS positioning resource sets included in the first list and 1≤N2≤maxNrofSRS-PosResourceSets. The above example means that the first list includes first N2 SRS positioning resource sets included in the maximum number of SRS positioning resource sets, and the third list includes the remaining (maxNrofSRS-PosResourceSets-N2) SRS positioning resource sets included in the maximum number of SRS positioning resource sets.

As another example, it is assumed that the maximum number of SRS positioning resource sets configured per UL BWP is denoted as maxNrofSRS-PosResourceSets, then:

| | |
|---|---|
| srs-RIS-PosResourceSetToAddModList | may be defined as |
| srs-RIS-PosResourceSetToAddModList ::= | SEQUENCE (SIZE(1 . . . N3)) OF |
| srs-RIS-PosResourceSet; and | |
| srs-PosResourceSetToAddModList | may be defined as: |
| srs-PosResourceSetToAddModList | ::= SEQUENCE (SIZE |

(N3+1 . . . maxNrofSRS-PosResourceSets) OF srs-PosResourceSet;

wherein N3 is the number of SRS positioning resource sets included in the second list, 1≤N3≤maxNrofSRS-PosResourceSets, and N3 may be equal to or not equal to N2. The above example means that the second list includes first N3 SRS positioning resource sets included in the maximum number of SRS positioning resource sets, and the fourth list includes the remaining (maxNrofSRS-PosResourceSets-N3) SRS positioning resource sets included in the maximum number of SRS positioning resource sets.

In some embodiments, srs-RIS-PosResourceSet may include parameters (also referred to as IEs) with definitions similar to those included in srs-PosResourceSet as specified in 3GPP standard documents.

For example, each SRS positioning resource set included in the first list or the second list may be defined by a set of parameters including at least one of:
a first parameter (e.g., denoted as srs-RIS-PosResourceSetId) indicating an ID of the SRS positioning resource set;
a second parameter (e.g., denoted as srs-RIS-PosResourceIdList) indicating IDs of SRS positioning resources in the SRS positioning resource set; or
a third parameter (e.g., denoted as RIS-resourceType) indicating that the SRS positioning resources in the SRS positioning resource set are periodic (e.g., indicated by RIS-periodic), semi-persistent (e.g., indicated by RIS-semi-persistent), or aperiodic (e.g., indicated by RIS-periodic).

In other words, srs-RIS-PosResourceSet may include at least one of the above parameters. In addition to the above parameters, srs-RIS-PosResourceSet may include other parameters with definitions similar to those included in srs-PosResourceSet as specified in 3GPP standard documents.

In some embodiments of the present application, after the SRS configuration transfer procedure, the BS may adjust coefficients of element(s) in an available RIS. For example, first, the BS may randomly select coefficients for elements in the available RIS. Then, the BS may transmit, to a UE (e.g., a target UE whose position needs to be known), reference signals via a cascade link including a link from the BS to the available RIS and a link from the available RIS to the UE. Based on the reference signals, the UE may determine a CSI report and transmit the CSI report of the cascade link to the BS. Then, the BS may tune the coefficients for element(s) in the available RIS based on the CSI report. In some examples, once the available RIS is enabled, the cascaded link may be estimated to derive the optimal reflecting coefficients of element(s) in the available RIS for the UE.

In some embodiments of the present application, for the RIS-assisted UL positioning, the LMF may calculate a positioning result of the UE.

FIG. 9 illustrates an exemplary procedure for calculating a positioning result of a UE based on a RIS-assisted UL positioning according to some embodiments of the present application. The method illustrated in FIG. 9 may be performed by at least two network entities, e.g., a BS (or a TRP) and an LMF. Although the method is illustrated in a system level, persons skilled in the art can understand that the method implemented in the two network entities can be separately implemented and incorporated in other apparatus with the like functions.

In the embodiments of FIG. 9, the BS may receive SRS(s) transmitted by the UE. The SRS(s) may be transmitted by the UE and received by the BS based on the SRS configuration(s) (e.g., UL-PRS configuration and UL-PRS-RIS configuration) configured by the BS as described above.

Referring to FIG. 9, in step 901, the LMF may transmit a measurement request message (e.g., which is an NRPPa message) to the BS. In response to receiving the measurement request message, in step 902, the BS may measure SRS(s) on a direct link from the UE to the BS and SRS(s) on a cascade link including a link from the UE to a RIS and a link from the RIS to the BS. Then, in step 903, the BS may transmit SRS measurement results of the direct link and the cascade link to the LMF in a measurement response message (e.g., which is an NRPPa message). After receiving the SRS measurement results of the direct link and the cascade link, in step 904, the LMF may calculate a positioning result of the UE based at least in part on the SRS measurement results.

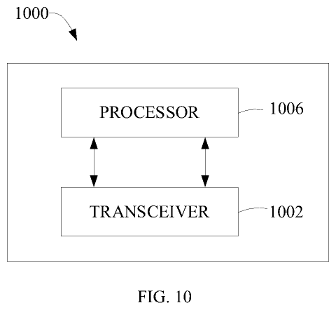

FIG. 10 illustrates a simplified block diagram of an exemplary apparatus 1000 for RIS-assisted positioning according to some embodiments of the present application. In some embodiments, the apparatus 1000 may be or include at least part of a UE (e.g., UE 102a or UE 102b in FIG. 1). In some other embodiments, the apparatus 1000 may be or include at least part of a BS (e.g., BS 101 in FIG. 1). In some other embodiments, the apparatus 1000 may be or include at least part of an LMF (e.g., LMF 103 in FIG. 1). In some other embodiments, the apparatus 1000 may be or include at least part of an AMF.

Referring to FIG. 10, the apparatus 1000 may include at least one transceiver 1002 and at least one processor 1006. The at least one transceiver 1002 is coupled to the at least one processor 1006.

Although in this figure, elements such as the transceiver 1002 and the processor 1006 are illustrated in the singular, the plural is contemplated unless a limitation to the singular is explicitly stated. In some embodiments of the present application, the transceiver 1002 may be divided into two devices, such as receiving circuitry (or a receiver) and transmitting circuitry (or a transmitter). In some embodiments of the present application, the apparatus 1000 may further include an input device, a memory, and/or other components. The transceiver 1002 and the processor 1006 may be configured to perform any of the methods described herein (e.g., the methods described with respect to FIGS. 2A-9 or other methods described in the embodiments of the present application).

According to some embodiments of the present application, the apparatus 1000 may be an LMF, and the transceiver 1002 and the processor 1006 may be configured to perform operations of an LMF as described with respect to FIGS. 2A-9 or other methods described in the embodiments of the present application. For example, the processor 1006 is configured to: transmit, via the transceiver 1002 and to a BS, a request message requesting PRS configuration(s) for a RIS-assisted DL positioning or SRS configuration(s) for a RIS-assisted UL positioning; and receive, via the transceiver 1002, the PRS configuration(s) or the SRS configuration(s) from the BS.

According to some embodiments of the present application, the apparatus 1000 may be a BS, and the transceiver 1002 and the processor 1006 may be configured to perform operations of a BS as described with respect to FIGS. 2A-2C, 3-5, and 7-9 or other methods described in the embodiments of the present application. For example, the processor 1006 is configured to: receive, via the transceiver 1002 and from an LMF, a request message requesting PRS configuration(s) for a RIS-assisted DL positioning or SRS configuration(s) for a RIS-assisted UL positioning; and transmit, via the transceiver, the PRS configuration(s) or the SRS configuration(s) to the LMF.

According to some embodiments of the present application, the apparatus 1000 may be a UE (e.g., a target UE whose position needs to be known), and the transceiver 1002 and the processor 1006 may be configured to perform operations of a UE as described with respect to FIGS. 2C, 2D, 5A, 5B, 6, and 8 or other methods described in the embodiments of the present application. For example, the processor 1006 is configured to: receive, via the transceiver 1002, PRS configuration(s) for a RIS assisted DL positioning or SRS configuration(s) for a RIS-assisted UL positioning; and receive, via the transceiver 1002, PRS(s) based on the PRS configuration(s) or transmit, via the transceiver 1002, SRS(s) based on the SRS configuration(s).

In some embodiments of the present application, the apparatus 1000 may further include at least one non-transitory computer-readable medium. In some embodiments of the present disclosure, the non-transitory computer-readable medium may have stored thereon computer-executable instructions to cause the processor 1006 to implement any of the methods as described above. For example, the computer-executable instructions, when executed, may cause the processor 1006 to interact with the transceiver 1002, so as to perform operations of the methods, e.g., as described with respect to FIGS. 2A-9 or other methods described in the embodiments of the present application.

The method according to any of the embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for RIS-assisted positioning, including a processor and a memory. Computer programmable instructions for implementing a method for RIS-assisted positioning are stored in the memory, and the processor is configured to perform the computer programmable instructions to implement the method for RIS-assisted positioning. The method for RIS-assisted positioning may be any method as described in the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for RIS-assisted positioning according to any embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A location management function (LMF), comprising:
at least one memory; and
at least one processor coupled with the at least one memory and configured to cause the LMF to:
transmit, to a base station, a request message requesting positioning reference signal (PRS) configuration(s) for a reconfigurable intelligent surface (RIS) assisted downlink (DL) positioning or sounding reference signal (SRS) configuration(s) for a RIS-assisted uplink (UL) positioning; and
receive the PRS configuration(s) or the SRS configuration(s) from the base station.

2. The LMF of claim 1, wherein the at least one processor is configured to cause the LMF to:
receive, from the base station, a transmission and reception point (TRP) information response message indicating a minimum number of TRPs and a number of candidate TRPs;
compare the number of candidate TRPs with the minimum number of TRPs; and
determine to initiate the RIS-assisted DL positioning or the RIS-assisted UL positioning in response to that the number of candidate TRPs is less than the minimum number of TRPs.

3. A base station, comprising:
at least one memory; and
at least one processor coupled with the at least one memory and configured to cause the base station to:
receive, from a location management function (LMF), a request message requesting positioning reference signal (PRS) configuration(s) for a reconfigurable intelligent surface (RIS) assisted downlink (DL) positioning or sounding reference signal (SRS) configuration(s) for a RIS-assisted uplink (UL) positioning; and
transmit the PRS configuration(s) or the SRS configuration(s) to the LMF.

4. The base station of claim 3, wherein the at least one processor is configured to cause the base station to:
receive a transmit-receive point (TRP) information request message from the LMF, compare a number of candidate TRPs with a minimum number of TRPs configured by the base station, and transmit, to the LMF, an indication indicating to initiate the RIS-assisted DL positioning or the RIS-assisted UL positioning in response to that the number of candidate TRPs is less than the minimum number of TRPs, wherein the indication is a RIS-assisted positioning request message or transmitted in a TRP information response message; or
compare a measured reference signal receiving power (RSRP) value with an RSRP threshold configured by the base station, and transmit, to the LMF, an indication indicating to initiate the RIS-assisted UL positioning in response to that the measured RSRP value is less than the RSRP threshold, wherein the indication is a RIS-assisted positioning request message or transmitted in a measurement response message.

5. The base station of claim 3, wherein the at least one processor is configured to cause the base station to receive information of available RIS(s) for the RIS-assisted DL positioning or the RIS-assisted UL positioning, wherein the information of the available RIS(s) includes at least one of:
location(s) of the available RIS(s) or a number of elements of each available RIS.

6. The base station of claim 5, wherein the at least one processor is configured to cause the base station to:
receive, from the LMF, a RIS capability request message requesting capability information of the available RIS(s); and
transmit the capability information of the available RIS(s) in response to receiving the RIS capability request message from the LMF, wherein the capability information includes capability of tuning coefficients and properties of RIS element(s) included in each of the available RIS(s) according to control information from the base station.

7. The base station of claim 6, wherein the at least one processor is configured to cause the base station to:
receive, from the LMF, the request message requesting the PRS configuration(s) after transmitting the capability information of the available RIS(s), wherein the PRS configuration(s) includes a PRS configuration for a direct link from the base station to a UE and a PRS configuration for a cascade link including a link from the base station to a RIS and a link from the RIS to the UE;
configure the PRS configuration for the direct link and the PRS configuration for the cascade link; and
transmit the PRS configuration for the direct link and the PRS configuration for the cascade link to the LMF.

8. The base station of claim 7, wherein the PRS configuration for the cascade link indicates a first list of DL PRS resource sets per TRP in each frequency layer, and wherein DL PRS resource set(s) included in the first list is different from DL PRS resource set(s) included in a second list of DL PRS resource sets which is configured per TRP in each frequency layer and included in the PRS configuration for the direct link from the base station to the UE.

9. The base station of claim 8, wherein each DL PRS resource set included in the first list is defined by a set of parameters including at least one of:
a first parameter indicating an identity (ID) of the DL PRS resource set;
a second parameter indicating a periodicity and an offset for the DL PRS resource set;
a third parameter indicating how many times each DL PRS resource is repeated for a single instance of the DL PRS resource set;
a fourth parameter indicating an offset between two repeated instances of a DL PRS resource;
a fifth parameter indicating a number of symbols of a DL PRS resource within a slot;
a sixth parameter indicating an average energy per resource element of the resources elements that carry PRS; or
a seventh parameter indicating a set of DL PRS resources.

10. The base station of claim 6, wherein the request message requesting the SRS configuration(s) is a positioning information request message, and the at least one processor is configured to cause the base station to:
receive, from the LMF, the positioning information request message after transmitting the capability information of the available RIS(s), wherein the SRS configuration(s) includes an SRS configuration for a direct link from a UE to the base station and an SRS configuration for a cascade link including a link from the UE to a RIS and a link from the RIS to the base station;
configure the SRS configuration for the direct link and the SRS configuration for the cascade link;
transmit, to the LMF, the SRS configuration for the direct link and the SRS configuration for the cascade link in a positioning information response message; and
transmit the SRS configuration for the direct link and the SRS configuration for the cascade link to the UE.

11. The base station of claim 6, wherein the request message requesting the SRS configuration(s) is a positioning activation request message, and the at least one processor is configured to cause the base station to:
receive, from the LMF, the positioning activation request message after transmitting the capability information of the available RIS(s), wherein the positioning activation request message actives an SRS transmission for a direct link from a UE to the base station and an SRS transmission for a cascade link including a link from the UE to a RIS and a link from the RIS to the base station and requests an SRS configuration for the direct link and an SRS configuration for the cascade link;
configure the SRS configuration for the direct link and the SRS configuration for the cascade link;
transmit the SRS configuration for the direct link and the SRS configuration for the cascade link in a positioning activation response message to the LMF;
transmit the SRS configuration for the direct link and the SRS configuration for the cascade link to the UE; and
activate the SRS transmission for the direct link and the SRS transmission for the cascade link.

12. The base station of claim 10, wherein:
the SRS configuration for the cascade link indicates at least one of a first list of SRS positioning resource sets to be released or a second list of SRS positioning resource sets to be added or modified; and
SRS positioning resource set(s) included in the first list is different from SRS positioning resource set(s) included in a third list of SRS positioning resource sets to be released which is configured for the direct link from the UE to the base station, or SRS positioning resource set(s) included in the second list is different from SRS positioning resource set(s) included in a fourth list of SRS positioning resource sets to be added or modified which is configured for the direct link.

13. The base station of claim 12, wherein each SRS positioning resource set included in the first list or the second list is defined by a set of parameters including at least one of:
a first parameter indicating an ID of the SRS positioning resource set;
a second parameter indicating IDs of SRS positioning resources in the SRS positioning resource set; or
a third parameter indicating that the SRS positioning resources in the SRS positioning resource set are periodic, semi-persistent, or aperiodic.

14. A user equipment (UE), comprising:
at least one memory; and
at least one processor coupled with the at least one memory and configured to cause the UE to:
receive positioning reference signal (PRS) configuration(s) for a reconfigurable intelligent surface (RIS) assisted downlink (DL) positioning or sounding reference signal (SRS) configuration(s) for a RIS-assisted uplink (UL) positioning; and
receive PRS(s) based on the PRS configuration(s) or transmit SRS(s) based on the SRS configuration(s).

15. The UE of claim 14, wherein the at least one processor is configured to cause the UE to:
receive, from a location management function (LMF), a provide assistance data message indicating a minimum number of TRPs configured by a base station and a number of candidate TRPs, compare the number of candidate TRPs with the minimum number of TRPs, and in response to that the number of candidate TRPs is less than the minimum number of TRPs, transmit a RIS-assisted positioning request message to the LMF to initiate the RIS-assisted DL positioning; or
in response to that a measured reference signal receiving power (RSRP) value is less than an RSRP threshold configured by the UE or a calculated positioning result is not satisfied with quality of service (QoS) requirements, transmit an indication indicating to initiate the RIS-assisted DL positioning to an LMF, wherein the indication is a RIS-assisted positioning request message or transmitted in a provide location information message.

16. A method performed by a base station, the method comprising:
receiving, from a location management function (LMF), a request message requesting positioning reference signal (PRS) configuration(s) for a reconfigurable intelligent surface (RIS) assisted downlink (DL) positioning or sounding reference signal (SRS) configuration(s) for a RIS-assisted uplink (UL) positioning; and
transmitting the PRS configuration(s) or the SRS configuration(s) to the LMF.

17. The method of claim 16, further comprising:
receiving a transmit-receive point (TRP) information request message from the LMF, compare a number of candidate TRPs with a minimum number of TRPs configured by the base station, and transmitting, to the LMF, an indication indicating to initiate the RIS-assisted DL positioning or the RIS-assisted UL positioning in response to that the number of candidate TRPs is less than the minimum number of TRPs, wherein the indication is a RIS-assisted positioning request message or transmitted in a TRP information response message; or
comparing a measured reference signal receiving power (RSRP) value with an RSRP threshold configured by the base station, and transmitting, to the LMF, an indication indicating to initiate the RIS-assisted UL positioning in response to that the measured RSRP value is less than the RSRP threshold, wherein the indication is a RIS-assisted positioning request message or transmitted in a measurement response message.

18. The method of claim 16, further comprising receiving information of available RIS(s) for the RIS-assisted DL positioning or the RIS-assisted UL positioning, wherein the information of the available RIS(s) includes at least one of: location(s) of the available RIS(s) or a number of elements of each available RIS.

19. The method of claim 18, further comprising:
receiving, from the LMF, a RIS capability request message requesting capability information of the available RIS(s); and
transmitting the capability information of the available RIS(s) in response to receiving the RIS capability request message from the LMF, wherein the capability information includes capability of tuning coefficients and properties of RIS element(s) included in each of the available RIS(s) according to control information from the base station.

20. The method of claim 19, further comprising:
receiving, from the LMF, the request message requesting the PRS configuration(s) after transmitting the capability information of the available RIS(s), wherein the PRS configuration(s) includes a PRS configuration for a direct link from the base station to a UE and a PRS configuration for a cascade link including a link from the base station to a RIS and a link from the RIS to the UE;
configuring the PRS configuration for the direct link and the PRS configuration for the cascade link; and
transmitting the PRS configuration for the direct link and the PRS configuration for the cascade link to the LMF.
